(19) United States
(12) Patent Application Publication
(10) Pub. No.: US 2012/0125507 A1
(43) Pub. Date: May 24, 2012

(54) TIRE WITH FOAMED NOISE DAMPER

(76) Inventors: René Louis Bormann, Moesdorf (LU); Giorgio Agostini, Colmar-Berg (LU); Ramendra Nath Majumdar, Hudson, OH (US)

(21) Appl. No.: 12/953,577

(22) Filed: Nov. 24, 2010

(51) Int. Cl. B60C 19/00; B29D 30/08; B60C 5/00

(52) U.S. Cl. 152/510; 427/244

(57) ABSTRACT

The present invention is directed to a method for making a tire having a foam noise damper, comprising the steps of: obtaining a tire having an innerliner, the innerliner having a surface facing an interior cavity of the tire; applying a foamable liquid to the surface; and foaming the foamable liquid to form a solid foam noise damper secured to the tire innerliner.

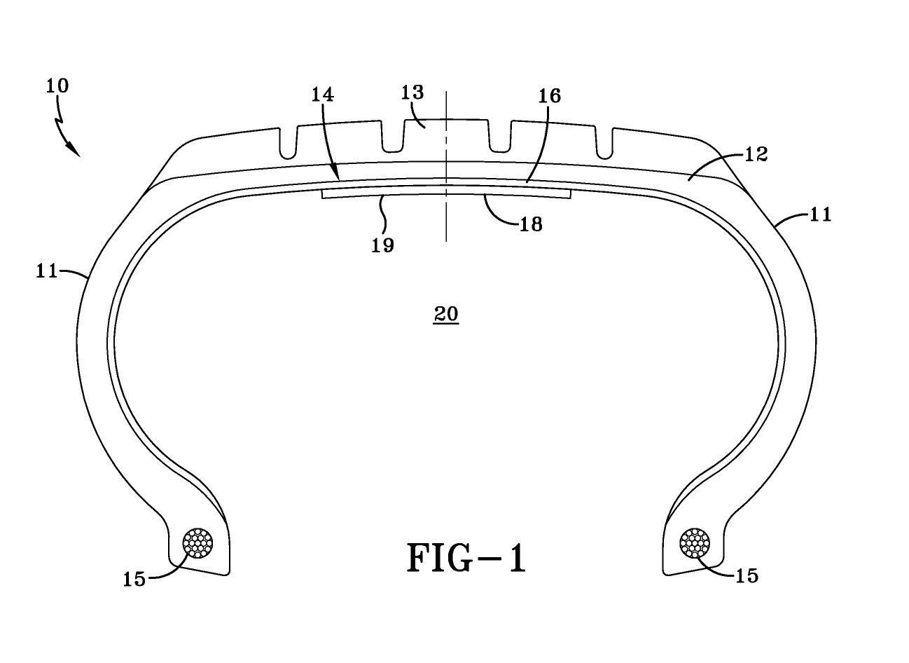

### BACKGROUND OF THE INVENTION

Government regulations and consumer preferences continue to compel a reduction in the acceptable noise levels produced from the tires of passenger vehicles. One source of road noise is resonance within the air chamber enclosed by the innermost surface of the tire and the rim. One type of effort to reduce tire noise is damping the sound from the air vibration in the air chamber, which efforts have focused mainly on altering the innermost surface of the tire adjacent the tire carcass. Shortcomings in these previous efforts, as well as new stricter regulations regarding noise reduction, have provided a need for further improvements to the tire to reduce sound transmission due to vibrations within the air chamber.

### SUMMARY OF THE INVENTION

The present invention is directed to a method for making a tire having a foam noise damper, comprising the steps of: obtaining a tire having an innerliner, the innerliner having a surface facing an interior cavity of the tire; applying a foamable liquid to the surface; and foaming the foamable liquid to form a solid foam noise damper secured to the tire innerliner.

The invention is further directed to a pneumatic tire comprising two spaced inextensible beads; a ground contacting tread portion; a pair of individual sidewalls extending radially inward from the axial outer edges of said tread portion to join the respective beads, the axial outer edges of the tread portion defining a tread width; a supporting carcass for the tread portion and sidewalls; an innerliner disposed radially inward of the carcass, the innerliner having a surface exposed to an inner cavity of the tire; and a foamed noise damper disposed on the surface of the innerliner; the foamed noise damper comprising a silicone rubber foam having a specific gravity in a range of from 0.01 to 0.4.

### BRIEF DESCRIPTION OF THE DRAWINGS

The invention will be more readily understood with respect to the accompanying drawing wherein:

The sole drawing is a cross-sectional view of an embodiment of a tire having a foamed noise damper according to the present invention.

### DEFINITIONS

“Carcass” means the tire structure apart from the belt structure, tread, undertread, beads and sidewall rubber over the plies.

“Innerliner” means the layer or layers of elastomer or other material that form the inside surface of a tire and that contain the inflating fluid within the tire. The “innerliner” of a tube-type tire is often called a “squeegee” to distinguish it from the innerliner of a tubeless tire.

“Pneumatic tire” means a laminated mechanical device of generally toroidal shape (usually an open torus) having beads and a tread and made of rubber, chemicals, fabric and steel or other materials. When mounted on the wheel of a motor vehicle, the tire through its tread provides traction and contains the fluid that sustains the vehicle load.

“Tread” means a molded rubber component which, when bonded to a tire casing, includes that portion of the tire that comes into contact with the road when the tire is normally inflated and under normal load, i.e., the footprint.

“Equatorial plane (EP)” means the plane perpendicular to the tire's axis of rotation and passing through the center of its tread.

The terms “cure” and “vulcanize” are intended to be interchangeable terms unless otherwise noted.

The terms “green” and “uncured” are intended to be interchangeable unless otherwise noted.

### DESCRIPTION OF THE INVENTION

In accordance with the present invention, there is provided a method for making a tire having a foam noise damper, comprising the steps of: obtaining a tire having an innerliner, the innerliner having a surface facing an interior cavity of the tire; applying a foamable liquid to the surface; and foaming the foamable liquid to form a solid foam noise damper secured to the tire innerliner.

There is further provided a pneumatic tire comprising two spaced inextensible beads; a ground contacting tread portion; a pair of individual sidewalls extending radially inward from the axial outer edges of said tread portion to join the respective beads, the axial outer edges of the tread portion defining a tread width; a supporting carcass for the tread portion and sidewalls; an innerliner disposed radially inward of the carcass, the innerliner having a surface exposed to an inner cavity of the tire; and a foamed noise damper disposed on the surface of the innerliner; the foamed noise damper comprising a silicone rubber foam having a specific gravity in a range of from 0.01 to 0.4.

By disposing a certain volume of the foam material in the tire cavity, resonances of the air in the cavity can be controlled and vibrations of the tread portion are reduced. Therefore, noise generated from the tire during running can be reduced. In particular, reduction of noise due to tire cavity resonance measured at a frequency of 200 to 300 Hz is desirable.

The foam noise damper has a specific gravity and dimensions suitable to reduce noise level due to tire cavity resonance at 200 to 300 Hz. In one embodiment, the foam has a specific gravity greater in a range of 0.01 to 0.4 (100 to 400 kg/m3). In one embodiment, the foam noise damper has a thickness in the tire radial direction ranging from 10 to 50 mm. In one embodiment, the foam noise damper has a width in the axial tire direction ranging from 30 to 150 mm. In one embodiment, the foam noise damper is disposed circumferentially about the tire.

The foam noise damper is formed and secured to the surface of the tire innerliner by foaming in place a foamable liquid precursor material. By foaming in place, it is meant that the foamable liquid precursor is applied to the surface of the tire innerliner as a liquid, and allowed to foam and cure while in contact with the surface of the tire innerliner.

In so doing, the method avoids prior art methods of applying a pre-made foam to the innerliner with an adhesive or other attachment method.

Precursor foamable liquids capable of forming foams including synthetic resin foams such as ether based polyurethane foam, ester based polyurethane foam, polyethylene foam and the like; rubber foams such as chloroprene rubber foam, ethylene-propylene rubber foam, nitrile rubber foam, silicone rubber foam and the like are suitable. Foamable liquids as known in the art, including various reactive monomers, blowing agents, and curatives, are suitable.

In one embodiment, the foamable liquid is a silicone rubber foam precursor and the foam noise damper is a silicone rubber foam noise damper. In one embodiment, the foamable liquid is an RTV (room temperature vulcanizable) silicone foam precursor. In one embodiment, the foamable liquid is a two-part RTV (RTV-2) silicone foam precursor. Suitable silicone foams may be produced by methods as are known in the art, as disclosed for example in U.S. Pat. No. 4,851,452 and U.S. Pat. No. 6,022,904. Suitable silicone foam rubber precursors are available commercially, for example as Elastocil® from Wacker Silicones, including Elastocil® SC 890 A/B.

The foamed noise damper can be disposed in various inner portions of the tire. For example it can extend from bead to bead for coverage of the innerliner spanning both the tread and sidewall portions of the tire or it can simply be selectively and locally disposed on the innerliner surface of the tire. In one embodiment, the foamed noise damper is disposed on the innerliner surface circumferentially and bisected by the equatorial plane of the tire.

The foamed noise damper of the tire is of such a gauge as to not occupy any substantial inner portion of the inflated tire. Generally, its thickness ranges from about 1 to about 80 and preferably about 10 to about 50 percent of the total tire thickness, depending somewhat upon the tire size and intended use of the tire with its structured volume being less than about 25 percent, preferably less than about 10 percent, of the encompassed volume of air in the pneumatic tire. Thus, a typical thickness is in the range of about 10 to about 30 percent of the total tire thickness for an ordinary passenger pneumatic tire with its volume being less than about 10 percent of the encompassed volume of air in the pneumatic tire.

In order to obtain an adequate noise dampening effect by the foamed noise damper in the tire, the foamed noise damper has a density or density and porosity in ranges suitable to dampen noise.

In one embodiment, the foamed noise damper has a specific gravity ranging from about 0.01 to about 0.4. In another embodiment, the foamed noise damper has a density ranging from 0.1 to about 0.4. In another embodiment, the foamed noise damper has a density ranging from about 0.15 to about 0.25 g/cm³.

The foamable liquid may be applied to the surface of the tire innerliner using various methods as are known in the art, including but not limited to spraying, brushing, rolling, wiping, and the like. In one embodiment, the foamable liquid is applied to the surface of the tire innerliner by spraying.

The foamable liquid may be applied to the surface of the tire innerliner as a freely formed body, i.e., without constraint of a mold, or the foamable liquid may be applied with the use of a removable mold to impart a desired cross-sectional area to the resulting foam noise damper. In one embodiment, a mold in utilized to impart a rectangular cross sectional area to the foam noise damper.

The foamable liquid may be applied in one continuous circumferential motion, to avoid breaks in the foam noise damper. The continuous motion may be achieved for example during spraying by movement of a movable spray head, or by rotation of the tire on a rotating support.

An advantage to application of the foam noise damper from a foamable liquid is the resulting absence of a splice in the foam noise damper. Such a splice, or overlap, is typically observed in foam noise dampers applied to a tire as prefoamed solid foam. The splice may undesirably provide a source of a separation of the foam from the innerliner during use. In one embodiment, then, the solid foam noise damper is exclusive of a splice.

In one embodiment, the foamable liquid is applied to the innerliner of a green, or uncured, tire. One advantage of such an application is good adhesion of the foamed noise damper to the tire innerliner. In the case of application to a cured tire, the presence of residual silicone release agent (used to facilitate release the tire from a curing mold) on the surface of the innerliner can interfere with adhesion of the foam to the innerliner. By contrast, application of the foamable liquid to the green innerliner of a green tire avoids such negative influence of release agents.

Whether the foamable liquid is applied to a green tire or cured tire, to ensure adhesion of the silicone rubber foam to the innerliner use of an adhesive is necessary. The adhesive is applied to the innerliner prior to application of the silicone rubber foam. In one embodiment, the adhesive is an acrylic adhesive. Suitable acrylic adhesive is available commercially as 6038 adhesive transfer tape from 3M.

It is readily understood by those having skill in the art that the rubber compositions used in the vulcanized rubber tire can be of various cured or vulcanized rubbers such as natural rubber and synthetic rubber and their mixtures or blends. For example, they can be rubbery styrene-butadiene copolymers, butadiene-acrylonitrile copolymers, cis-1,4-polyisoprene, polybutadiene, isoprene-butadiene copolymers, butyl rubber, halogenated butyl rubber such as chloro or bromo butyl rubber, ethylene-propylene copolymers, ethylene-propylene-diene terpolymers and polyurethane elastomers. Typically the various polymers are cured or vulcanized by normal curing methods and recipes such as with sulfur, or with peroxides in the case of the ethylene-propylene copolymers, or with primary diamines in the case of polyurethane elastomers. The sulfur cured or vulcanized natural rubber and synthetic rubbery polymers are preferred such as styrene-butadiene rubber, cis-1,4-polyisoprene, polybutadiene, butyl rubber, chlorobutyl rubber, and bromobutyl rubber.

It is further understood by those having skill in the art that the rubber compositions used components other than the noise damper in the tire would be compounded by methods generally known in the rubber compounding art, such as mixing the various sulfur-vulcanizable constituent rubbers with various commonly used additive materials such as, for example, curing aids, such as sulfur, activators, retarders and accelerators, processing additives, such as oils, resins including tackifying resins, silicas, and plasticizers, fillers, pigments, fatty acid, zinc oxide, waxes, antioxidants and antiozonants, peptizing agents and reinforcing materials such as, for example, carbon black. As known to those skilled in the art, depending on the intended use of the sulfur vulcanizable and sulfur vulcanized material (rubbers), the additives mentioned above are selected and commonly used in conventional amounts.

The rubber compound may contain various conventional rubber additives. Typical additions of carbon black comprise about 20 to 200 parts by weight per 100 parts by weight of diene rubber (phr), preferably 50 to 100 phr.

A number of commercially available carbon blacks may be used. Included in the list of carbon blacks are those known under the ASTM designations N299, S315, N326, N330, M332, N339, N343, N347, N351, N358, N375, N539, N550 and N582. Processing aids may be present and can include, for example, aromatic, naphthenic, and/or paraffinic processing oils. Typical amounts of tackifying resins, such as phenolic tackifiers, range from 1 to 3 phr. Silica, if used, may be used in an amount of about 5 to about 80 phr, often with a silica coupling agent. Representative silicas may be, for example, hydrated amorphous silicas. Typical amounts of antioxidants comprise about 1 to about 5 phr. Representative antioxidants may be, for example, diphenyl-p-phenylenediamine, polymerized 1,2-dihydro-2,2,4-trimethylquinoline and others, such as, for example, those disclosed in the Vanderbilt Rubber Handbook (1990), Pages 343 through 362. Typical amounts of antiozonants comprise about 1 to about 5 phr. Representative antiozonants may be, for example, those disclosed in the Vanderbilt Rubber Handbook (1990), Pages 363 through 367. Typical amounts of fatty acids, if used, which can include stearic acid comprise about 0.5 to about 3 phr. Typical amounts of zinc oxide comprise about 2 to about 10 phr. Typical amounts of waxes comprise about 1 to about 5 phr. Often microcrystalline waxes are used. Typical amounts of peptizers comprise about 0.1 to about 1 phr. Typical peptizers may be, for example, pentachlorothiophenol and dibenzamidodiphenyl disulfide.

The vulcanization is conducted in the presence of a sulfur vulcanizing agent. Examples of suitable sulfur vulcanizing agents include elemental sulfur (free sulfur) or sulfur donating vulcanizing agents, for example, an amine disulfide, polymeric polysulfide or sulfur olefin adducts. Preferably, the sulfur vulcanizing agent is elemental sulfur. As known to those skilled in the art, sulfur vulcanizing agents are used in an amount ranging from about 0.5 to about 5 phr, or even, in some circumstances, up to about 8 phr, with a range of from about 3 to about 5 being preferred.

Accelerators are used to control the time and/or temperature required for vulcanization and to improve the properties of the vulcanizate. In one embodiment, a single accelerator system may be used, i.e., primary accelerator. Conventionally, a primary accelerator is used in amounts ranging from about 0.5 to about 2.5 phr. In another embodiment, combinations of two or more accelerators which is generally used in the larger amount (0.5 to 2.0 phr), and a secondary accelerator which is generally used in smaller amounts (0.05 to 0.50 phr) in order to activate and to improve the properties of the vulcanizate. Combinations of these accelerators have been known to produce a synergistic effect of the final properties and are somewhat better than those produced by use of either accelerator alone. In addition, delayed action accelerators may be used which are not affected by normal processing temperatures but produce satisfactory cures at ordinary vulcanization temperatures. Suitable types of accelerators that may be used in the present invention are amines, disulfides, guanidines, thioureas, thiazoles, thiurams, sulfenamides, dithiocarbamates and xanthates. Preferably, the primary accelerator is a sulfenamide. If a second accelerator is used, the secondary accelerator is preferably a guanidine, dithiocarbamate or thiuram compound.

The tire can be built, shaped, molded and cured by various methods, which will be readily apparent to those having skill in such art.

Referring now to the drawing it is shown that a pneumatic rubber tire can be prepared by building an unshaped and unvulcanized basic tire 10 containing what are to become the customary tread portion 13, sidewalls 11, beads 15 and carcass 12, which typically contains plies (not shown) to back and reinforce the tread and sidewall portions, and particularly a foamed noise damper 18. The green tire 10 has the foamed noise damper 18 in place, after application, foaming and cure of a foamable liquid. The green tire is then placed in a mold where it is shaped, molded and heated under pressure to vulcanize the tire.

In the embodiment as shown in the drawing, the tire 10 includes innerliner layer 16 disposed adjacent the carcass 12 and foamed noise damper 18 disposed on the surface 14 of innerliner 16 and forming the innermost surface 19, with foamed noise damper 18 bisected by equatorial plane 20 and extending circumferentially and axially over less than the full width of the tread 13.

Thus, in one embodiment the foamed noise damper may extend circumferentially about the inside of the tire and axially from bead to bead. In another embodiment, the foamed noise damper may extend circumferentially about the inside of the tire and only partially across the width of the tire. In one embodiment, the foamed noise damper may extend axially no more than 50 percent of the tread width. In another embodiment, the foamed noise damper may extend axially in a range of from about 10 percent to 50 percent of the tread width. In another embodiment, the foamed noise damper may be substantially centered axially on the axial centerline of the tire. In another embodiment, multiple circumferential foamed structures may be used, disposed so as to equalize the load on the tire and maintain dynamic balance.

While certain representative embodiments and details have been shown for the purpose of illustrating the invention, it will be apparent to those skilled in this art that various changes and modifications may be made therein without departing from the spirit or scope of the invention.

What is claimed is:

1. A method for making a tire having a foam noise damper, comprising the steps of:
obtaining a tire having an innerliner, the innerliner having a surface facing an interior cavity of the tire;
applying a foamable liquid to the surface; and
foaming the foamable liquid to form a solid foam noise damper secured to the tire innerliner.

2. The method of claim 1, further comprising the step of:
applying an adhesive to the surface prior to disposing the foamable liquid to the surface surface, wherein the adhesive is between the foamable liquid and the surface.

3. The method of claim 2, wherein the foamable liquid is a silicone rubber foam precursor and the foam noise damper is a silicone rubber foam noise damper.

4. The method of claim 2, wherein the foamable liquid is an RTV silicone foam precursor.

5. The method of claim 2, wherein the foamable liquid is a two-part RTV (RTV-2) silicone foam precursor.

6. The method of claim 2, wherein the foam noise damper has a specific gravity ranging from 0.01 to 0.4.

7. The method of claim 2, wherein the foam noise damper has a specific gravity ranging from 0.1 to 0.4.

8. The method of claim 2, wherein the foam noise damper has a specific gravity ranging from 0.15 to 0.25.

9. The method of claim 1, wherein the tire is an uncured green tire and the innerliner is a green uncured innerliner.

10. The method of claim 9, further comprising the step of: curing the uncured green tire having the solid foam noise damper secured to the green uncured innerliner.

11. The method of claim 1, wherein the step of applying a foamable liquid to the surface comprises applying the foamable liquid in a continuous circumferential motion.

12. The method of claim 10, wherein the solid foam noise damper is exclusive of a splice.

13. A pneumatic tire comprising two spaced inextensible beads; a ground contacting tread portion; a pair of individual sidewalls extending radially inward from the axial outer edges of said tread portion to join the respective beads, the axial outer edges of the tread portion defining a tread width; a supporting carcass for the tread portion and sidewalls; an innerliner disposed radially inward of the carcass, the innerliner having a surface exposed to an inner cavity of the tire; and a foamed noise damper disposed on the surface of the innerliner; the foamed noise damper comprising a silicone rubber foam having a specific gravity in a range of from 0.01 to 0.4.

14. The pneumatic tire of claim 13, wherein the foam noise damper has a specific gravity ranging from 0.15 to 0.25.

15. The pneumatic tire of claim 13, wherein the foam noise damper is exclusive of a splice.
